(19) United States
(12) Patent Application Publication
(10) Pub. No.: US 2010/0098403 A1
(43) Pub. Date: Apr. 22, 2010

(54) Image Capture Device Having An Adjustable Front-Facing Viewfinder

(75) Inventor: Dennis Sones, San Rafael, CA (US)

Correspondence Address: Venture Pacific Law, PC, 5201 Great America Parkway, Suite 270, Santa Clara, CA, 95054, US

(73) Assignee: Silverlink International Ltd., Hong Kong (HK)

(21) Appl. No.: 12/604,386

(22) Filed: Oct. 22, 2009

Related U.S. Application Data
(60) Provisional application No. 61/107,664, filed on Oct. 22, 2008.

(51) Int. Cl. G03B 13/02

(52) U.S. Cl. 396/383

(57) ABSTRACT

An adjustable front-facing viewfinder for an image capture device is disclosed. The image capture device comprises: a lens; a front side, wherein the lens is positioned on the front side; and a viewfinder, wherein the viewfinder is disposed on the front side, wherein the viewfinder comprises of one or more tiles that indicates a field of vision of the image capture device, and wherein the viewfinder is adjustable.

### CROSS REFERENCE

This application claims priority from a provisional patent application entitled “Systems and Methods for Recording an Image Using an Image Capture Device” filed on Oct. 22, 2008 and having an Application No. 61/107,664. Said application is incorporated herein by reference.

### FIELD OF INVENTION

This invention relates to an image capture device having an adjustable front-facing viewfinder, and, in particular, to an adjustable viewfinder for protecting the lens of the image capture device and for providing a viewfinder positioned on the front face of the image capture device.

### BACKGROUND

Due to the popularity of image capture devices and the ease at which images can be shared and transferred, taking a “good” picture is of great importance. Many image capture devices, including digital cameras, photographic-film cameras, digital video recorders, camcorders, web-cams, camera phones, and other image capture devices, have a plethora of functions and capabilities to enhance image quality.

For instance, a standard digital camera can have image stabilizing capabilities, a zoom lens, an optical viewfinder, a liquid crystal display (“LCD”) viewfinder, a red eye correction function, a movie mode with sound, expandable memory capabilities, a hand strap, a tripod connector, a light sensor to measure ambient light, a light illumination device (e.g., a flash), face recognition software, automatic focus, and other functions. The provided functions and capabilities allow a camera user to record an image (e.g., take a picture) in various situations, such as in low light to very bright light, where the subject of the image is moving at high speeds or is moving at low speeds, where the subject is miles away from the camera to where the subject is within an inch of the camera, and for many other conceivable situations.

However, these functions do not offer much assistance, if any, when a user takes a picture in which the user is not able to see the optical viewfinder or the LCD viewfinder. Such a case occurs when the user attempts to take a self portrait, without the aid of equipment (e.g. a tripod) and without the aid of other people. Traditionally, the optical viewfinder and the LCD viewfinder are positioned on the back of a camera, which is on the side opposite from the camera lens. Therefore, if the user takes a picture in which he/she is on the same side as the camera lens, then the user cannot use the optical viewfinder or LCD viewfinder to see the field of vision of the camera lens or to determine other information that can be conveyed on a viewfinder including lighting conditions, if the camera is shaking, or other conditions. Furthermore, even if the user is on the same side, if the camera is extended away from the user's face, then the user may not be able to ascertain the field of vision. Here, a field of vision can mean an image (or a portion of the image) as seen through the camera lens and/or the viewfinders.

FIG. 1 illustrates a user taking a self portrait unassisted by equipment or by other people. A user holds a camera 2 out at arm's length, pointing the lens of the camera 2 in the user's direction. The user is not able to see the optical viewfinder or the digital view finder because these traditional viewfinders are positioned on the back of the camera. Thus, the user cannot precisely aim the camera.

Although, the user can take multiple pictures on a trial and error basis to see what the final recorded image looks like, this may not be feasible when the camera 2 has limited image storage capacity, such as if the images are recorded on a photographic film or if the camera 2 lacks memory space on its digital storage media. Also, this would not be viable since time constraints may not permit the user from being able to take multiple pictures. Furthermore, by not being able to quickly capture the moment, that moment is lost. Overall, the spontaneity and efficiency for taking pictures are greatly diminished.

FIG. 2 illustrates a user taking a picture with a group of other people. A user points the lens of a camera 4 to take a picture of the user and two other people. Once again, the problem arises where the user is not able to ascertain what the camera lens is pointing at and subsequently recording. This can result in “bad” pictures, where the subjects of the image may be off center or cutoff. In addition, other unaesthetic results from not being able to see the optical viewfinder or the LCD viewfinder positioned on the back side of the camera may also occur since valuable information, including lightening levels and focusing, may be indicated on the traditional LCD viewfinder which the user cannot see from the front side of the camera.

FIG. 3 illustrates a user taking a picture, where the user's view is obstructed such that the user extends the camera to a point where the user can no longer ascertain what the camera lens is recording. Here, a user is not taking a picture of himself/herself, but still runs into the problem of not being able to ascertain what the camera lens is pointing at, and subsequently recording, because the camera 6 is extended from the user in such a way that the user cannot position himself/herself accordingly to ascertain the expected recorded image via the optical view finder or via the LCD viewfinder of the camera 6, which are both positioned on the back side of the camera.

In an attempt to solve such problems, current technologies have placed a fixed mirror on the front face of a camera, adjacent to the camera lens, to enable observations of the range or field of the scene to be photographed from the front of the camera. However, the known art does not accurately display the field of vision of the camera lens since the mirror is not adjusted to take into account the distance between the mirror and the camera lens. Additionally, other information relating to obtaining an optimal picture (e.g., lighting conditions, camera movement, and other photo conditions) is not conveyed through the mirror to the subject of the camera. Furthermore, the mirror is relatively small and positioned awkwardly such that a subject of the camera cannot easily surmise the field of vision of the camera lens. The current technologies also lack any other useful functionality aside from displaying a small portion of the field of vision of the camera lens.

Therefore, it is desirable to provide a view finder that can protect the camera lens from the outside environment and can allow the subject of the camera (e.g., one or more people facing the camera lens) to quickly ascertain the field of vision of the camera lens and the other information that may affect the image quality.

### SUMMARY OF INVENTION

An object of this invention is to provide an image capture device having an adjustable front-facing viewfinder capable of conveying information relevant to recording an image.

Another object of this invention is to provide an image capture device having an adjustable front-facing viewfinder connected to the body of the capture device by a sliding mechanism, which allows for adjustment in viewing the viewfinder and for completely covering the lens of the capture device.

Yet another object of this invention is to provide an image capture device having an adjustable front-facing viewfinder which can serve to protect the lens of the camera and to accurately display the field of vision of the lens.

Furthermore, another object of this invention is to provide methods for a user to record the user's self image or other image using an image capture device by disposing an adjustable reflective surface on the front of the capture device to indicate the field of vision of the lens of the capture device.

Briefly, an adjustable front-facing viewfinder for an image capture device is disclosed. The image capture device comprises: a lens; a front side, wherein the lens is positioned on the front side; and a viewfinder, wherein said viewfinder is disposed on the front side, wherein said viewfinder comprises of one or more tiles that indicates a field of vision of said image capture device, and wherein the viewfinder is adjustable in relation to the front side.

An advantage of this invention is that an image capture device having an adjustable front-facing viewfinder capable of conveying information relevant to recording an image is provided.

Another advantage of this invention is an image capture device having an adjustable front-facing viewfinder connected to the body of the capture device by a sliding mechanism, which allows for adjusting the viewfinder and for completely covering the lens of the capture device, is provided.

Yet another advantage of this invention is an image capture device having an adjustable front-facing viewfinder, which can protect the lens of the camera and accurately display the field of vision of the lens, is provided.

Furthermore, another advantage of this invention is methods for a user to record the user's self image or other image using an image capture device by disposing an adjustable reflective surface on the front of the capture device to indicate the field of vision of the lens of the capture device are provided.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a user taking a self portrait unassisted by equipment or by other people.

FIG. 2 illustrates a user taking his/her picture with a group of other people.

FIG. 3 illustrates a user taking a picture, where the user extends the camera to a point where the user can no longer clearly view the traditional optical viewfinder or the traditional LCD viewfinder.

FIG. 4 illustrates an image capture device of the present invention having an adjustable viewfinder, wherein the viewfinder is positioned at an angle from the front side of the capture device.

FIG. 5 illustrates an image capture device of the present invention having an adjustable viewfinder, where the viewfinder is aligned with the front side of the capture device.

FIG. 6 illustrates an image capture device of the present invention having an adjustable viewfinder, where the viewfinder is a concave mirror positioned along the front side of the capture device.

FIG. 7 illustrates an image capture device of the present invention having an adjustable viewfinder, where the viewfinder substantially overlaps with the front side of the capture device.

FIGS. 8a-8c illustrate various embodiments of an image capture device of the present invention, where a viewfinder is positioned at various angles relative to the front side of the image capture device.

FIG. 9 illustrates an image capture device of the present invention having an adjustable viewfinder, where the viewfinder has a plurality of tiles of different shapes and sizes.

FIGS. 10a-10e illustrate various views of an image capture device of the present invention having a slidable viewfinder with one tile.

FIGS. 11a-11d illustrate various views of an image capture device of the present invention having a slidable viewfinder with two tiles.

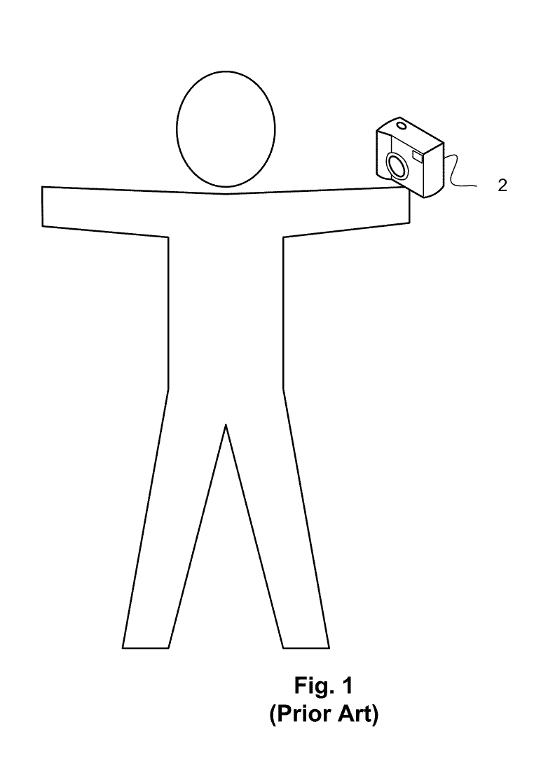

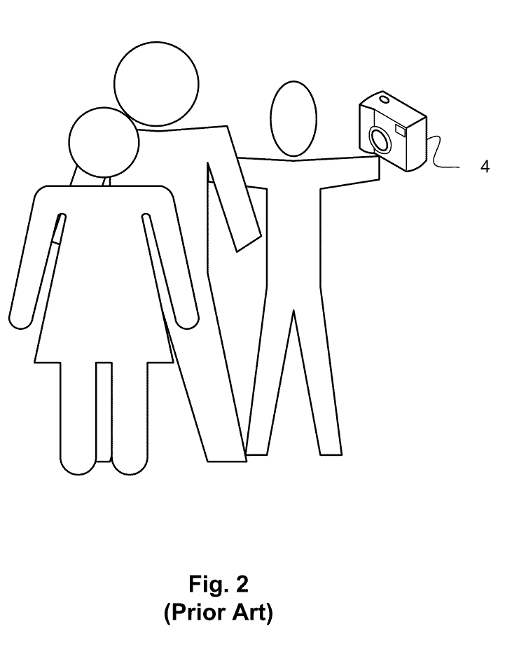

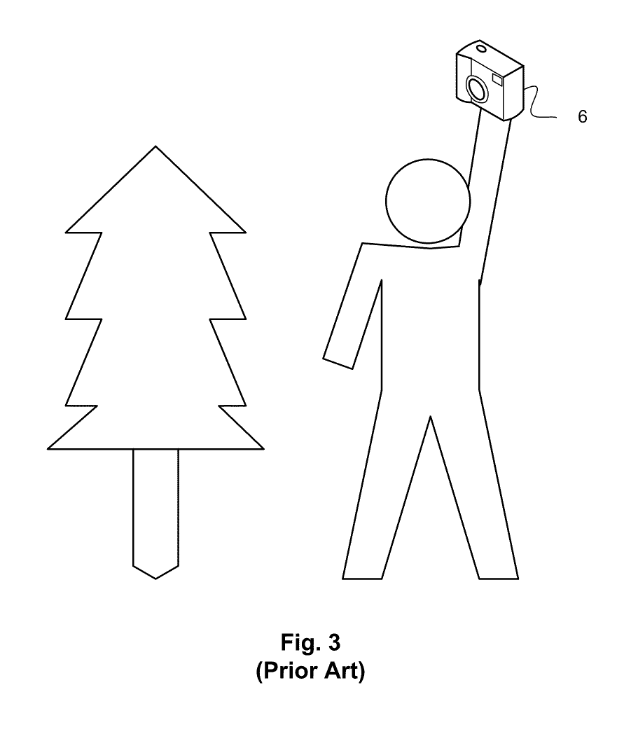

### DETAILED DESCRIPTION OF THE PREFERRED EMBODIMENTS

To simplify the description of this invention, a digital camera will be used to illustrate an image capture device, but in no way is this to limit the invention to a digital camera. In fact, the present invention can apply to any and all image capture devices, including digital cameras, photographic-film cameras, digital video recorders, camcorders, web-cams, camera phones, and other image capture devices.

Traditionally, a digital camera has a camera lens located on a front side of the camera (herein referred to as the front face), and an optical viewfinder and a LCD viewfinder located on the back side of the camera (herein referred to as the back face). In addition, to the viewfinders on the back side, an adjustable viewfinder of the present invention can be placed on the front side to provide the field of vision of the lens to subjects positioned on the front side of the camera. The viewfinder may be herein referred to as a front-facing viewfinder. The front-facing viewfinder is extremely helpful when the user of the camera is facing the front side of the camera, and thus cannot see the viewfinders on the back side of the camera. For the purpose of this application, adjustable may mean slideable, tiltable, movable, or otherwise adjustable in general.

Furthermore, the front-facing viewfinder may be slid along the body of the camera for adjusting the viewfinder in relation to the body of the camera. For instance, the angle of the viewfinder from the body of the camera can be adjusted to allow a subject of the camera to easily view the viewfinder and/or to accurately display the field of vision of the camera. Also, the viewfinder can be attached such that the viewfinder can serve as a slidable lens cover for the lens of the camera. Thus, the viewfinder can protect the lens of the camera.

In the preferred embodiments, a viewfinder can be attached to the front side of the camera such that the field of vision can be provided by the viewfinder. The viewfinder can also be attached to the outer edges of the camera such that the field of vision can be provided by the viewfinder.

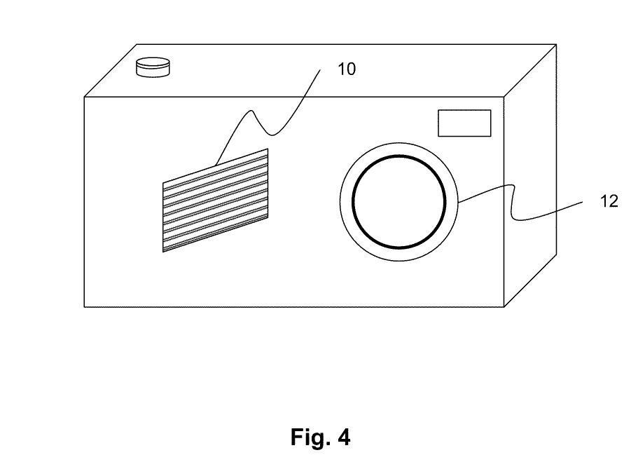

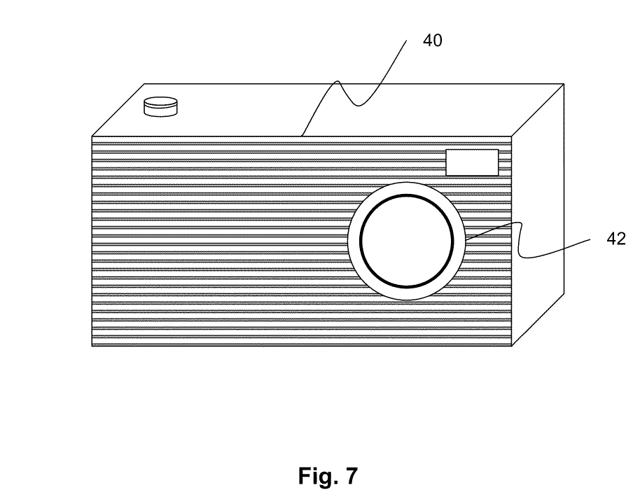

The viewfinder may be attached to a portion of the side to which it is located or may be attached to the entire side. For instance, if the viewfinder is located on the front side of the camera, then the viewfinder may be a portion of the front side of the camera (illustrated in FIG. 4), or alternatively may occupy the entire region of the front side of the camera (illustrated in FIG. 7). Furthermore, the viewfinder can also be placed on one of the outer edges of the camera. Additionally, the viewfinder may occupy or extend from the one or more edges in conjunction with the front side of the camera, and all variations thereof.

FIG. 4 illustrates an image capture device of the present invention having an adjustable viewfinder, wherein the viewfinder is positioned at an angle in relation to the front side of the capture device. A viewfinder 10 and a camera lens 12 are positioned on a portion of the front side of a camera. The angle of the viewfinder 10 can be adjusted to alter the field of vision of the viewfinder 10 to match the field of vision of the camera lens.

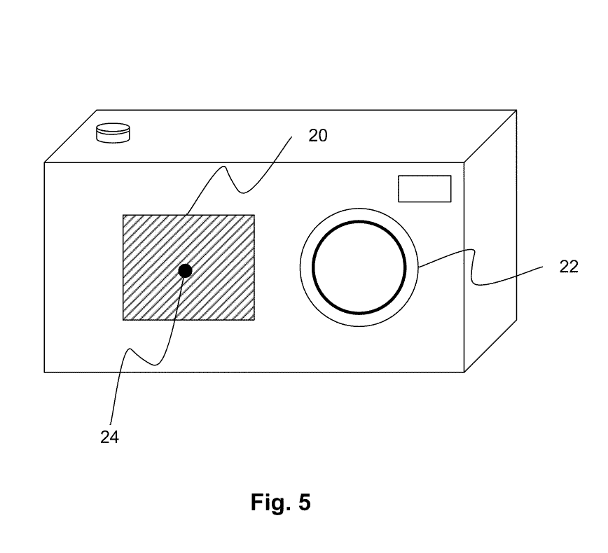

FIG. 5 illustrates an image capture device of the present invention having an adjustable viewfinder, where the viewfinder is aligned with the front side of the capture device. A viewfinder 20 and a camera lens 22 are positioned on a portion of the front side of a camera. The viewfinder 20 can be attached to a flat surface of the front side with a pivotable connector 24. In addition, if adjustments to the viewfinder 20 is required for a more optimal viewing of the viewfinder 20, the viewfinder 20 can be adjusted accordingly by the pivotable connector 24, accordingly. Any pivotable connector means, or other similar technologies can be used to implement the connection between the viewfinder and the camera body.

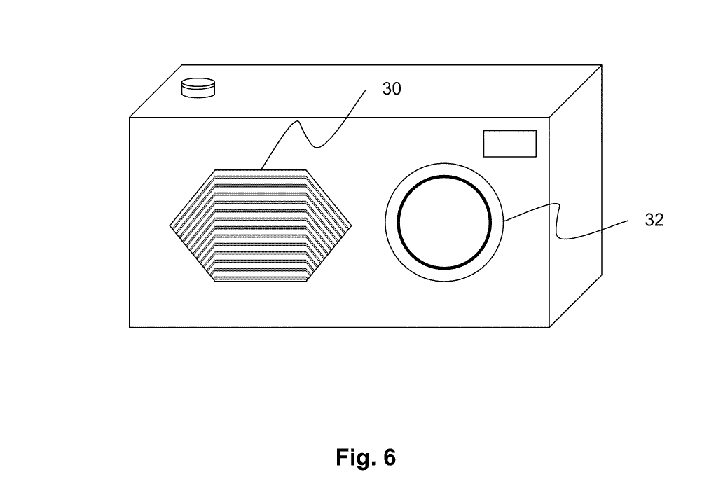

FIG. 6 illustrates an image capture device of the present invention having an adjustable viewfinder, where the viewfinder is a concave mirror positioned along the front side of the capture device. A viewfinder 30 and a camera lens 32 are positioned on a portion of the front side of a camera. The structure of the viewfinder 30 can be shaped in various configurations to optimized the field of vision. For instance, the shape of the viewfinder 30 can be convex, concave, square, circle, hexagonal, or other regular or irregular shapes. Furthermore, the viewfinder can be linearly adjusted or angularly adjusted in relation to the front side of the camera.

FIG. 7 illustrates an image capture device of the present invention having an adjustable viewfinder, where the viewfinder substantially overlaps the front side of the capture device. A viewfinder 40 and a camera lens 42 are positioned on the front side of a camera. The viewfinder 40 can substantially cover the front the side of the camera to provide for a larger surface area to view the field of vision of the camera lens 42.

### Material of the Viewfinder

The viewfinder can be a reflective material (e.g. tin, silver, aluminum, mercury, copper, or other compound) or simply a reflective coating.

In addition to the reflective coating, a protective coating can be placed on top of the reflective material and/or coating to protect to the reflective material from scratches, stains, sun damage, impact damages, and other possible damage that may occur to the outer casing of a camera.

The viewfinder may also have light sensitive properties, such that the viewfinder may change color depending on the amount of ambient light incident on the surface of the viewfinder. In this manner, the viewfinder can indicate to a subject facing the front of the camera the brightness level of the surrounding area. The subject can then determine whether the lighting is adequate for the picture without having to expend time by taking several test shots and reviewing the test shots to determine whether the pictures are adequately lighted.

### Structure of the Viewfinder

The viewfinder can be one or more tiles, where each tile may be of various shapes (e.g. rectangle, circle, hexagon, tear drop, an irregular shape, or other shapes). For instance, the viewfinder can be one tile of rectangular shape or circular shape. The viewfinder can also be four rectangular tiles, wherein each tile may be of various sizes. The viewfinder can also comprise of a mix-match of shapes, e.g. one rectangular tile and two circular tiles.

In addition to the two dimensional shapes of the one or more tiles of the viewfinder, each tile may be flat, convex, concave, rising at an edge, dipping at a corner, or other variations. This allows the viewfinder to indicate the camera's field of vision, where the camera's field of vision is the image (and surrounding areas) that the camera can record. For instance, a viewfinder comprising one tile can have a reflective convex surface to emphasize certain regions in the camera's field of vision. Furthermore, a concave reflective mirror viewfinder can be slightly raised at one edge by 1/16^{th} inch from the front side of the camera.

The advantage of using multiple tiles is that various tiles can give various fields of vision such that the user of the camera can ascertain surrounding objects in the field of vision. It may also serve to magnify certain regions that may be of interest, e.g. the subject to which the camera is pointing at or even objects to which the camera is not pointing at.

### Angle of the Viewfinder

The viewfinder can comprise of one or more tiles, wherein each tile may be placed at defined angles from the surface of the camera to which it lays. One purpose is so that the central subject in the field of vision (e.g. the user) to which the camera is taking a picture can be seen by a user standing in front of the camera at the various distances (of the user from the camera) or at the various zoom ranges of the camera.

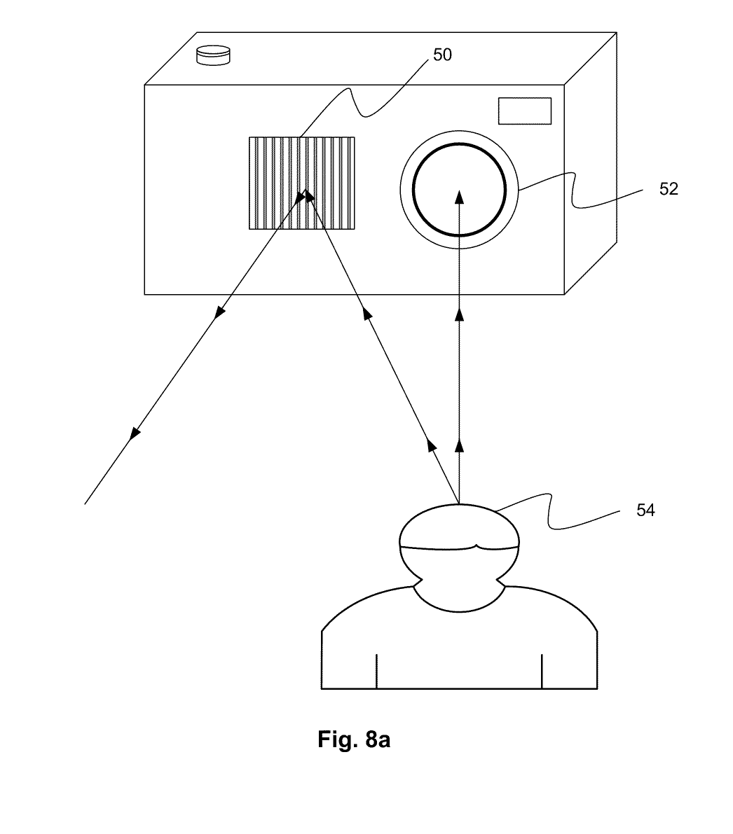

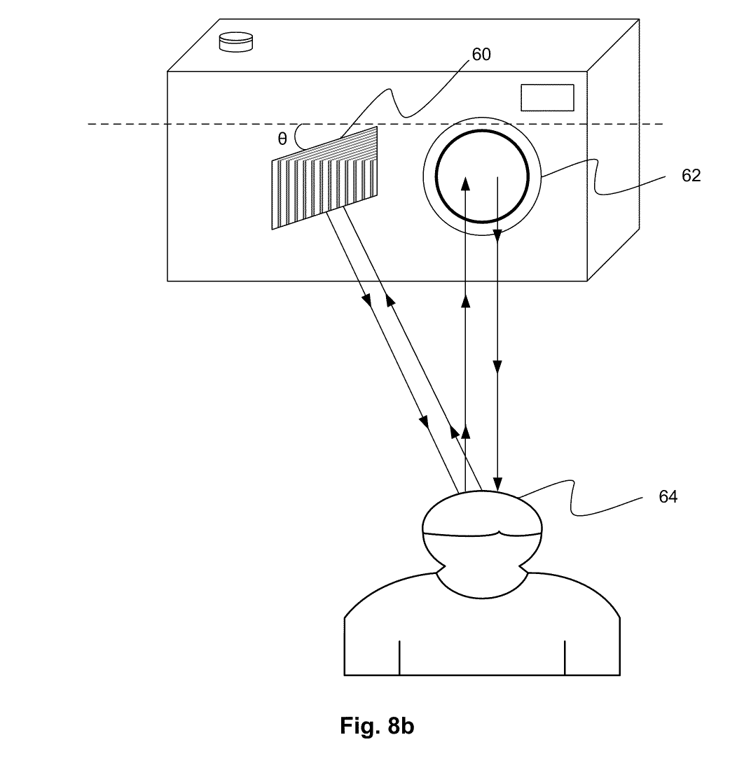

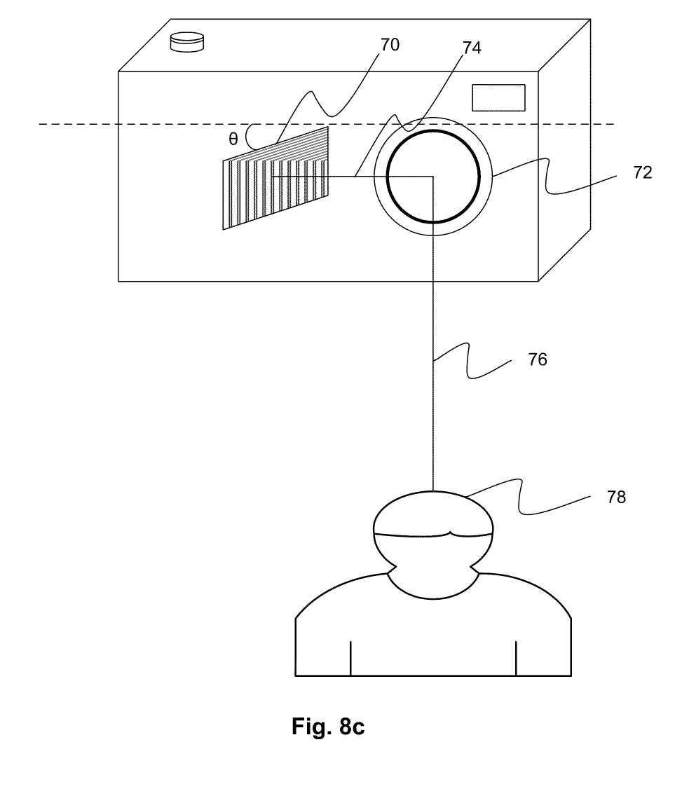

If the reflective surface were merely flat without being raised by one or more angles, then the viewfinder might not reflect the camera lens' field of vision since there is an offset between the viewfinder and the camera lens. FIG. 8a illustrates a flat viewfinder for a camera. A user 54 is positioned facing the front side of a camera. A viewfinder 50 and a camera lens 52 are positioned on the front side. Since the viewfinder 50 and the camera lens 52 are spaced a distance away from each other, the field of vision that the user 54 sees on the viewfinder 50 is not exactly that of the camera lens 52.

FIG. 8b illustrates an angled viewfinder where the angled viewfinder allows a subject of the camera to roughly pinpoint the area that the camera lens is pointing. Here, a viewfinder 60 is angled θ from the front side of the camera to account for the distance between the viewfinder 60 and camera lens 62.

An optimal angle to use for adjusting the viewfinder 60 can be found by first finding the average distance from the camera to the subject to which the camera is taking a picture (for example the average arm length for men and for women since a man or woman might be holding the camera to take a self portrait, or at fixed distances, 3 feet, 5 feet, 7 feet, 10 feet, etc.) or at the various zoom ranges of the camera. Next, the viewfinder 60 can be adjusted to the optimal angle such that the viewfinder 60 can accurately reflect the subject.

In an embodiment of the present invention, the viewfinder 60 can be a reflective convex surface. The convex surface is raised on an edge of the convex surface at an angle in relation to the front side, wherein the viewfinder is substantially large enough to display the field of vision of the lens such that a user can see what the lens is capturing when the user holds the image capture device at arm's length.

FIG. 8c illustrates one of many ways to calculate an optimal angle to set the one or more tiles of the viewfinder for viewing. Generally, a camera would be at a fixed distance from the user (e.g. 1 foot, 2 feet, 3 feet, 4 feet, 5 feet, 6 feet, etc.) 76 or at certain zoom range of the lens. Furthermore, the offset 74 between a camera lens 72 and a viewfinder 70 can vary from two to three inches. Therefore, the angle, θ, can be given through geometric analysis to find the optimum angle.

Additionally, other angles and variations from the optimal angle may be used for the purposes of this invention since an unlimited number of variations can be used to reflect the camera's field of vision.

The viewfinder can comprise one or more tiles, wherein each tile may be set at various angles from the surface of the camera to which that tile is attached. For instance, the viewfinder can be one tile wherein that tile is raised by a defined angle θ. The viewfinder can also be curved such that one edge of the viewfinder is raised by a certain distance compared to the opposite edge of the viewfinder. For instance, the right part of the viewfinder on the front side can be raised 1/16 of an inch compared to the left side of the viewfinder which is flush with the camera's surface, as illustrated in FIG. 4. Alternatively, the viewfinder can be one flat tile that is flush with the camera's surface, such that θ=0 degrees.

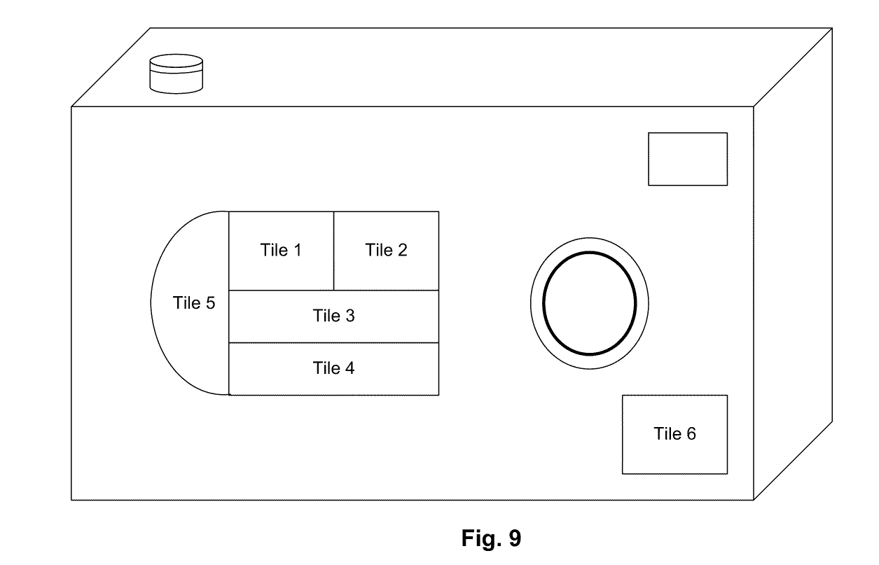

Additionally, the viewfinder may comprise of a plurality of tiles such that each tile may be raised various angles. FIG. 9 illustrates a viewfinder where there are five tiles. Two of the tiles (Tile 1 and Tile 2) are raised by an angle, θ₁, the other two tiles (Tile 3 and Tile 4) are raised by θ₂, and the fifth tile (Tile 5) is raised by an angle, θ₃. Another example is providing a viewfinder that is generally concave in shape raising at one edge comprising of a multitude of small reflective mirrors (like a concave disco ball).

### LCD Viewfinder

In addition to the various location, shape, and angle of the viewfinder, the viewfinder may be a LCD screen. Therefore, the LCD screen can display the camera's field of vision. FIG. 5 illustrates a camera where the viewfinder is a LCD screen.

### Adjustable Front-Facing Viewfinder

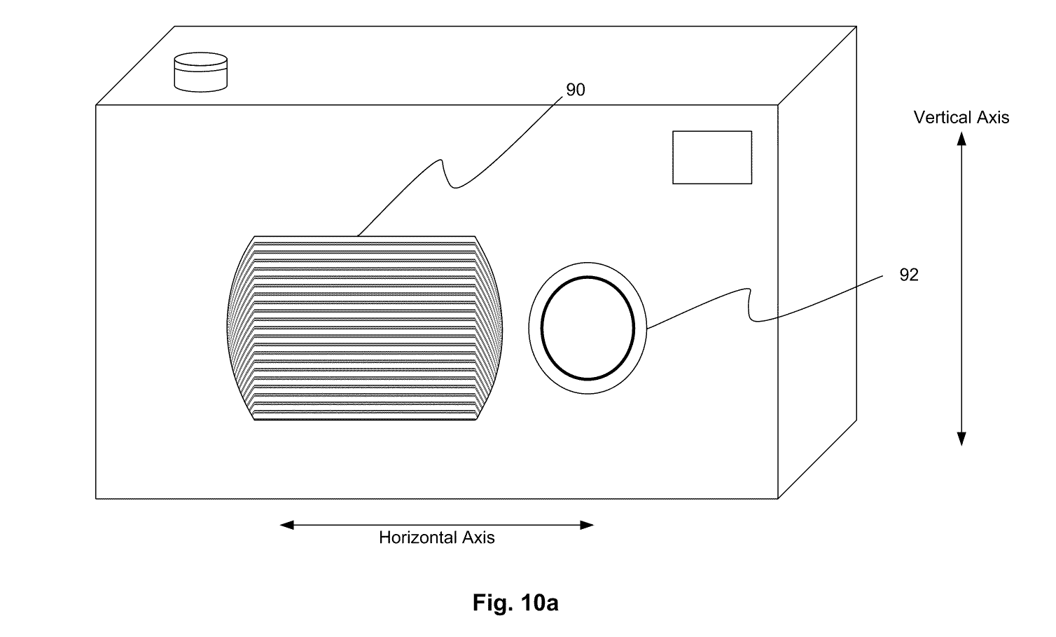

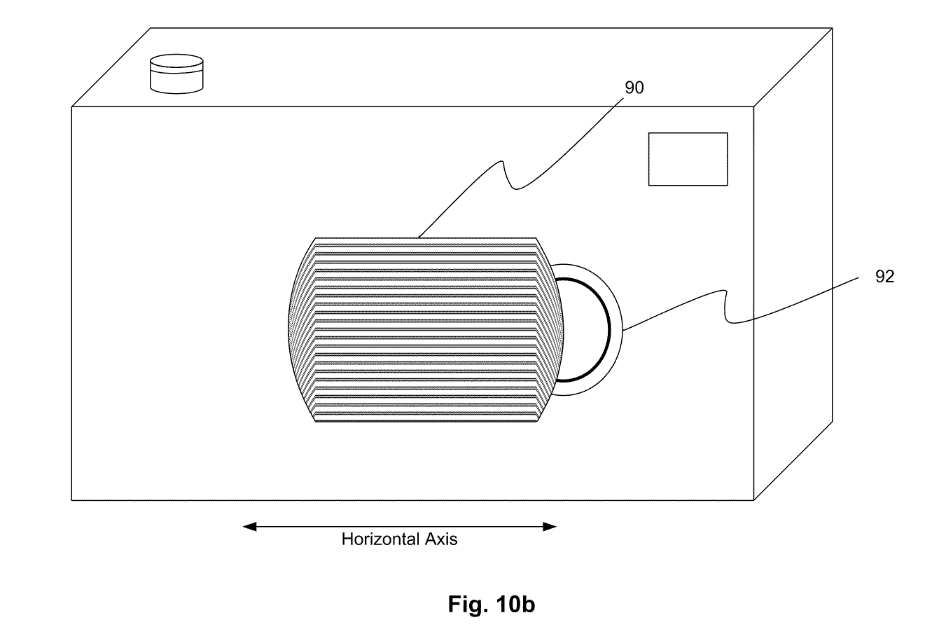

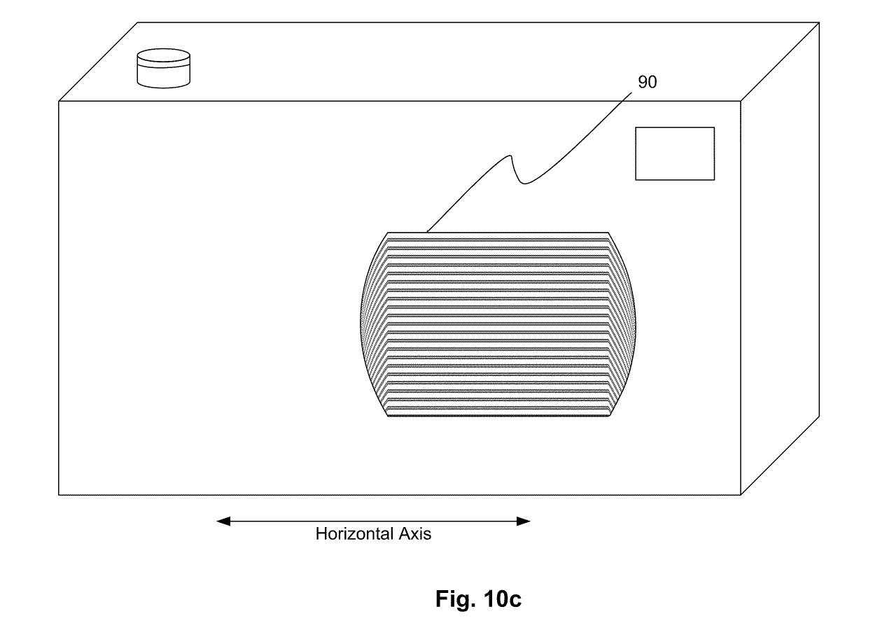

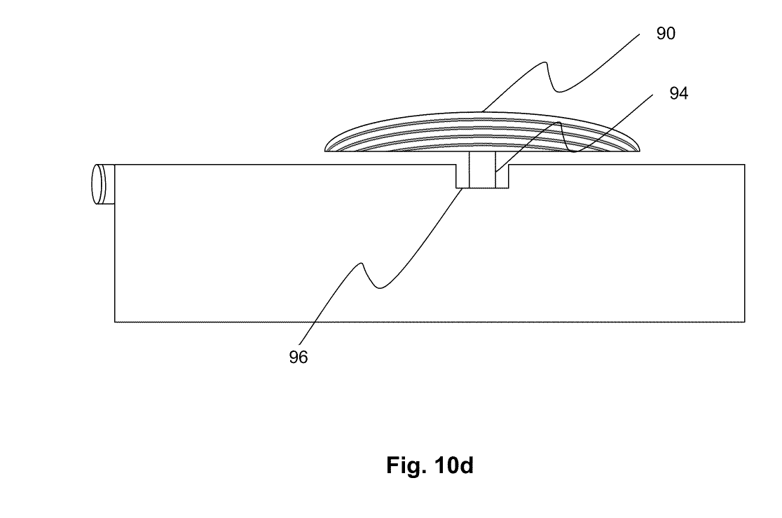

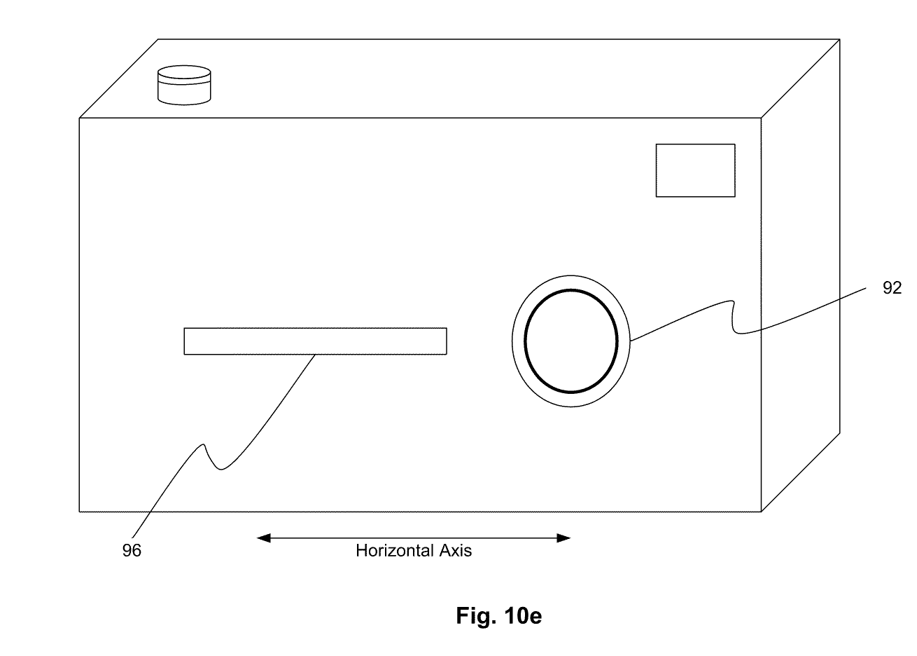

FIG. 10a illustrates a slidable viewfinder for a camera in an opened state. A slidable viewfinder 90 is positioned on the front face of the camera. The slidable viewfinder 90 is in an open position, meaning that the slidable viewfinder 90 is not obstructing the camera lens 92 in taking a photograph. When the slidable viewfinder 90 is in the open position, the camera may be used to take pictures.

The viewfinder 90 is attached to the camera body using a sliding mechanism to allow for the viewfinder 90 to slide along a horizontal axis of the camera. The viewfinder 90 can be slid such that it covers the entire camera lens 92; thereby, protecting the lens 92 from the outside environment. Alternatively, the viewfinder 90 can be slid to allow for a user to adjust the field of vision that is displayed, reflected, or otherwise indicated by the viewfinder 90. This allows for the subject of the camera to ascertain the field of vision of the camera lens 92, and obtain an indication of a recorded picture without having to first take a test picture and reviewing the test picture.

Although embodiments relating to the present invention may disclose a slidable viewfinder, which is movable along a horizontal direction of the camera, it is to be understood that a viewfinder can be adjusted along any direction along a plane that is parallel to the surface of the camera lens and/or camera body. For instance, a slidable viewfinder may be movable along a vertical direction, or possibly even a horizontal direction relative to the camera lens and/or camera body.

FIG. 10b illustrates a slidable viewfinder for a camera in a half-open state. Here, the viewfinder 90 is positioned covering a portion of the lens 92 of a camera. As indicated by the arrows below the viewfinder 90, the viewfinder 90 can be moved to an open position or a closed position.

FIG. 10c illustrates a slidable viewfinder for a camera in a closed state. A viewfinder is positioned on the front face of the camera. The viewfinder 90 is in a closed position, meaning that the viewfinder is positioned over the camera lens 92, thus, completely obstructing the camera lens 92. When the slidable viewfinder 90 is in the closed position, the camera lens 92 is protected from damage from the outside environment and external forces, including dust, dirt, scratches, and so forth.

FIG. 10d illustrates a side view of a slidable viewfinder for a camera. The viewfinder 90 is positioned directly above the camera body on the front side. There is a protrusion 94 extending from within the camera body and connected to the viewfinder 90. The slidable viewfinder 90 moves linearly along a groove 96 such that the viewfinder 90 can cover the lens 92 (e.g., a closed state) or uncover the lens 92 (e.g., an opened state).

In other embodiments, one or more protrusions can be connected to the sliding viewfinder 90 via one or more guiding grooves in such a manner that the protrusions can slide along the guiding grooves. Multiple guiding groves and multiple protrusions may be used to provide a more robust and sturdier sliding mechanism. The sliding mechanism of a viewfinder can also be implemented by other sliding technologies.

FIG. 10e illustrates a front view of a camera having a guiding grove for a slidable viewfinder. The guiding groove 96 allows for a viewfinder (not shown in this figure for the purpose of illustrating the guiding grove) to slide along the guiding groove 96 to cover the lens 92 in the closed stated and for uncovering the lens 92 for an opened state.

Note that any sliding mechanism can be implemented to move the viewfinder along the camera body. The example provided above is one example of the many sliding mechanisms.

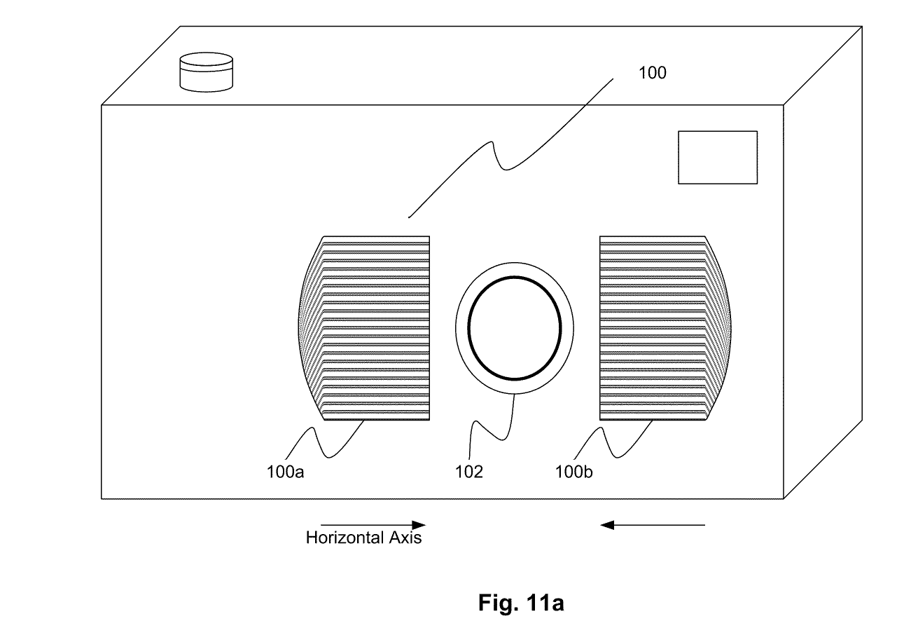

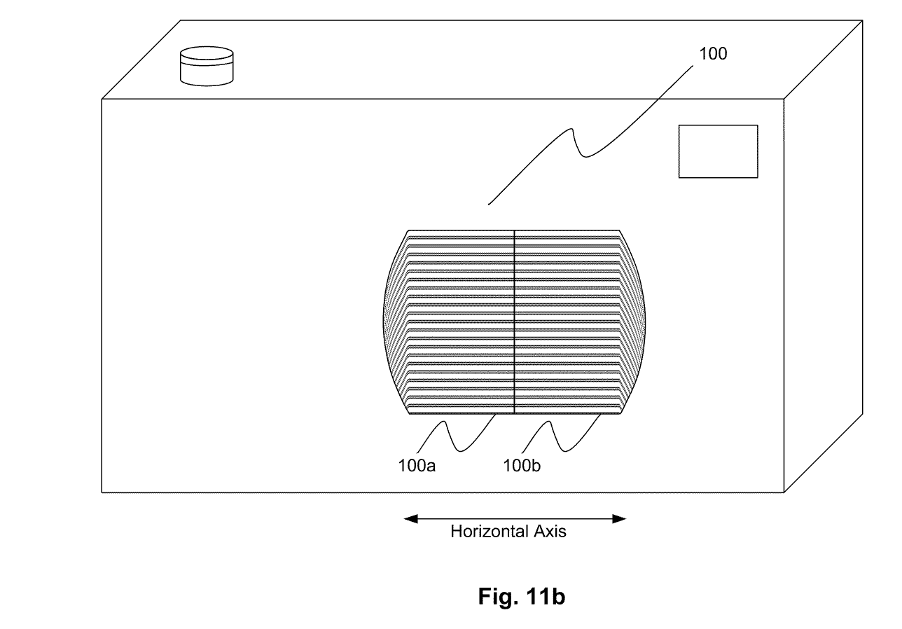

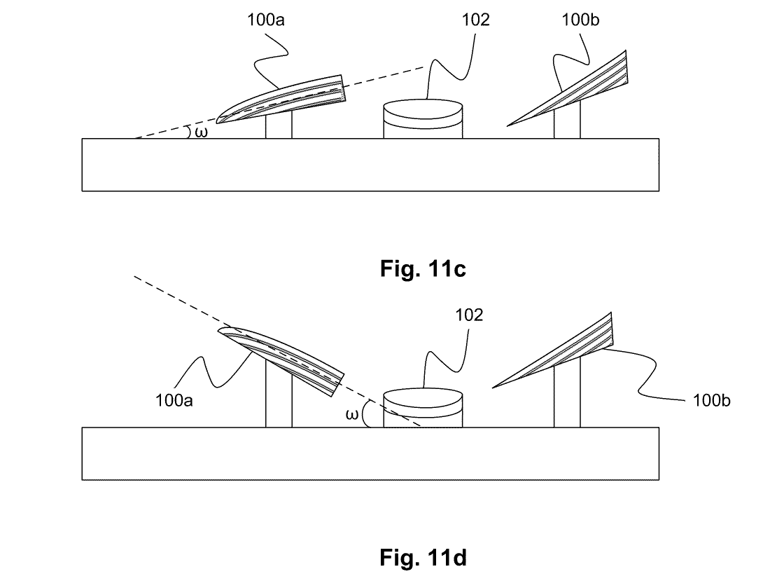

FIG. 11a illustrates a two-tile slidable viewfinder for a camera in an opened stated. A two piece slidable viewfinder 100 is similarly slid along a horizontal axis for an open state and a closed stated of a lens 102. Although various embodiments disclosed in above having one piece or two piece viewfinders, it is understood that multiple tiles can be used for the adjustable viewfinder.

The viewfinder 100 can be split such that one portion 100a of the viewfinder is positioned on one side of the lens and the other portion 100b of the viewfinder is positioned on the other side of the lens. This provides a wider field of vision for a subject to view.

Furthermore, various information can be displayed on various different portions of the viewfinder 100. For instance, the first portion 100a may indicate ambient light levels in the surrounding environment, and the second portion 100b may indicate the stability of the camera (i.e., whether the camera is shaking).

Alternatively, one portion 100a may be a reflective surface for indicating what the picture will look like, whereas the second portion 100b can be a LCD screen indicating a white balance setting for special effects.

FIG. 11b illustrates a two-tile slidable viewfinder for a camera in a closed stated. Similarly, to the closed state of the single tile slidable viewfinder, the two-tile slidable viewfinder 100 allows for the protection of the camera lens from the outside environment and external forces.

In addition to a slidable feature of the viewfinder 100, the viewfinder may also be adjusted such that the relative angle of the viewfinder can be altered in accordance to an optimal angle, or at other angles and variations.

FIGS. 11c-11d illustrate a two-tile adjustable viewfinder for a camera in an opened stated. Each of the tiles (portions 100a and 100b) can be angled an angle ω from the front body of the camera. The angle can be adjusted by a user or set by an optimal angle discussed above.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. An image capture device, comprising:
a lens;
a front side, wherein the lens is positioned on the front side; and
a viewfinder, wherein said viewfinder is disposed on the front side, wherein said viewfinder comprises one or more tiles that indicate one or more fields of vision of said lens, and wherein the viewfinder is adjustable.

2. The image capture device of claim 1 further comprising a sliding mechanism for adjusting the one or more tiles of the viewfinder.

3. The image capture device of claim 1 wherein the viewfinder is capable of being positioned to completely cover the lens.

4. The image capture device of claim 1 wherein said viewfinder is one or more tiles each having a reflective surface.

5. The image capture device of claim 4 wherein one or more of said tiles are raised at an angle from the surface of the front side of said image capture device.

6. The image capture device of claim 4 wherein said tiles having zero or more convex tiles.

7. The image capture device of claim 4 wherein said tiles having zero or more concave tiles.

8. The image capture device of claim 6 wherein said tiles having zero or more concave tiles.

9. The image capture device of claim 1 wherein said viewfinder is a LCD screen.

10. The image capture device of claim 1 further comprises one or more grooves and one or more protrusions to connect the one or tiles of the viewfinder to said image capture device.

11. The image capture device of claim 1 further comprises one or more pivotable connectors for connecting the one or tiles of the viewfinder to said image capture device.

12. The image capture device of claim 1 wherein each of said tiles provides for reflection for a different distance between the lens and a subject.

13. The image capture device of claim 1 wherein each of said tiles provides for reflection for a different distance between the lens and a subject.

14. The image capture device of claim 1 wherein each of said tiles provides for reflection for a different zoom range of the lens and a subject.

15. The image capture device of claim 13 wherein each of said tiles provides for reflection for a different zoom range of the lens and a subject.

16. An image capture device, comprising:
a lens;
a front side, wherein the lens is positioned on the front side; and
a viewfinder having one or more tiles, wherein said tiles are disposed on the front side each at a respective angle in relation to the front side to indicate a field of vision of said lens, and wherein the tiles are fixed to the front side.

17. An image capture device, comprising:
a lens having a field of vision;
a front side, wherein the lens is positioned on the front side; and
a viewfinder, wherein said viewfinder is a reflective convex tile and the reflective convex tile is raised at an angle in relation to the front side, wherein the tile capturing the field of vision reflective of a user holding the image capture device at arm's length.
